(19) United States
(12) Patent Application Publication
(10) Pub. No.: US 2020/0016948 A1
(43) Pub. Date: Jan. 16, 2020

(54) METAL-RESIN COMPOSITE MEMBER

(71) Applicant: F-TECH INC., Kuki-shi (JP)

(72) Inventors: Toshitaka Izumi, Haga-gun (JP); Hidetaka Yoshida, Haga-gun (JP); Naohiro Noma, Haga-gun (JP)

(73) Assignee: F-TECH INC., Kuki-shi (JP)

(21) Appl. No.: 16/506,140

(22) Filed: Jul. 9, 2019

(30) Foreign Application Priority Data
Jul. 10, 2018 (JP) 2018-130684
May 31, 2019 (JP) 2019-102258

(51) Int. Cl. B60G 7/00; B32B 15/08; B32B 3/26; B29C 43/18

(52) U.S. Cl. CPC B60G 7/001; B32B 15/08; B32B 3/266; B29K 2705/02; B32B 2262/106; B32B 2605/00; B29C 43/18

(57) ABSTRACT

In a metal-resin composite member 1, 1′, a first member M made of metal and a second member P, P′ made of resin are joined to each other via a first joining portion B defined by the first member M and the second member P, P′ in cooperation with each other, and the first member M made of metal and a third member P, P′ made of resin are joined to each other via a second joining portion B defined by the first member M and the third member P, P′ in cooperation with each other.

### BACKGROUND OF THE INVENTION

The present invention relates to a metal-resin composite member, and more particularly relates to a metal-resin composite member applied to strength parts or the like of a vehicle such as an automobile.

In recent years, composite strength parts that are a combination of a metal member and a resin member have been proposed not only for an aircraft and the like but also for a vehicle such as an automobile, in order to realize weight reduction while the strength and rigidity of the strength parts are secured at a same or higher level thereof.

Under such circumstances, U.S. Patent Application Publication No. 2004/070129 relates to a power transmission strut that is a chassis part of a vehicle such as a passenger car, and discloses a configuration that includes a metal insert M completely surrounded by a plastic part K by an injection molding process.

### SUMMARY OF THE INVENTION

However, studies by the inventors of the present application have revealed the following problems. The configuration of Patent Literature 1 is directed to realize weight reduction and ensure the strength and rigidity at the same time. However, this configuration has a configuration that surrounds the metal insert M with the plastic part K by using an injection molding process, and therefore requires use of a mold that is relatively large and sophisticated, leading to increase in manufacturing cost. With regard to this point, there is still a room for improvement.

The present invention has been made as a result of the above studies and an object of the present invention is to provide a metal-resin composite member capable of reducing the weight while the strength and rigidity are secured at a same or higher level thereof without using any complicated mold.

In order to achieve the above object, a first aspect of the present invention provides a metal-resin composite member comprising: a first member made of metal; a second member made of resin; and a third member made of resin, wherein the first member and the second member are joined to each other via a first joining portion defined by the first member and the second member in cooperation with each other, and the first member and the third member are joined to each other via a second joining portion defined by the first member and the third member in cooperation with each other.

According to a second aspect of the present invention, in addition to the first aspect, the resin configuring the second member and the resin configuring the third member include a portion where continuous fibers are arranged, a portion where discontinuous fibers are arranged, and a portion where the continuous fibers and the discontinuous fibers are not arranged, and the first joining portion and the second joining portion are configured by at least one of the portion where the discontinuous fibers are arranged and the portion where the continuous fibers and the discontinuous fibers are not arranged.

According to a third aspect of the present invention, in addition to the first aspect or second aspect, the first member, the second member, and the third member have through holes, respectively, and are mutually joined via the first joining portion and the second joining portion in a mode in which the second member and the third member are opposed to each other with the first member sandwiched therebetween in such a manner that the through holes are arranged coaxially with one another to allow insertion of a bush therethrough, the second member and the third member include flange portions respectively corresponding to the through holes, and the bush is retained by the flange portion of the second member and the flange portion of the third member.

According to a fourth aspect of the present invention, in addition to any one of the first to third aspects, the first member, the second member, and the third member are mutually joined via the first joining portion and the second joining portion in a mode in which the second member and the third member are opposed to each other with the first member sandwiched therebetween in such a manner that the first member and the second member define an internal space and the first member and the third member define an internal space.

According to a fifth aspect of the present invention, in addition to any one of the first to fourth aspects, the first member, the second member, and the third member each have a pair of through holes arranged in a longitudinal direction to be opposed to each other, the second member and the third member each include a pair of connecting wall portions that are opposed to each other in a width direction perpendicular to the longitudinal direction and extend in the longitudinal direction to connect peripheral wall portions of the pair of through holes to each other, and a rib that extends in the longitudinal direction between the pair of connecting wall portions to connect the peripheral wall portions of the pair of through holes to each other, and a width of the pair of connecting wall portions in the width direction is set to be the thickest in a center portion in the longitudinal direction, and a height of the rib in a height direction perpendicular to the longitudinal direction and the width direction is set to be the lowest in a center portion in the longitudinal direction.

According to the configuration of the first aspect of the present invention, in a metal-resin composite member, a first member made of metal and a second member made of resin are joined to each other via a first joining portion defined by the first member and the second member in cooperation with each other, and the first member made of metal and a third member made of resin are joined to each other via a second joining portion defined by the first member and the third member in cooperation with each other. Therefore, it is possible to reduce the weight while the strength and rigidity are secured at a same or higher level thereof without using any complicated mold.

According to the configuration of the second aspect of the present invention, the resin configuring the second member and the resin configuring the third member include a portion where continuous fibers are arranged, a portion where discontinuous fibers are arranged, and a portion where the continuous fibers and the discontinuous fibers are not arranged, and the first joining portion and the second joining portion are configured by at least one of the portion where the discontinuous fibers are arranged and the portion where the continuous fibers and the discontinuous fibers are not arranged. Therefore, by using a relation that a linear expansion coefficient (a thermal expansion coefficient) of each of the portion where the discontinuous fibers are arranged and the portion where the continuous fibers and the discontinuous fibers are not arranged is closer to a linear expansion coefficient of a metal portion than a linear expansion coefficient of the portion where the continuous fibers are arranged, it is possible to fill a gap between the linear expansion coefficient of the portion where the continuous fibers are arranged and the linear expansion coefficient of the metal portion with the linear expansion coefficient of each of the portion where the discontinuous fibers are arranged and the portion where the continuous fibers and the discontinuous fibers are not arranged correspondingly, to realize a smooth change between the linear expansion coefficient of the portion where the continuous fibers are arranged and the linear expansion coefficient of the metal portion, so that the use durability of the metal-resin composite member with respect to a temperature change can be increased. In addition, it is possible to increase the strength of joining between a resin member and a metal member by using a relation that the portion where the discontinuous fibers are arranged and the portion where the continuous fibers and the discontinuous fibers are not arranged are higher in the strength of joining to the metal portion than the portion where the continuous fibers are arranged.

According to the configuration of the third aspect of the present invention, the first member, the second member, and the third member have through holes, respectively, and are mutually joined via the first joining portion and the second joining portion in a mode in which the second member and the third member are opposed to each other with the first member sandwiched therebetween in such a manner that the through holes are arranged coaxially with one another and allow insertion of a bush therethrough. The second member and the third member have flange portions respectively corresponding to the through holes thereof, and the bush is retained by the flange portion of the second member and the flange portion of the third member. Therefore, it is possible to suppress division of a lower arm in the metal member when the second member and the third member are broken, and is also possible to position and retain the bush by the flange portions.

According to the configuration of the fourth aspect of the present invention, the first member, the second member, and the third member are mutually joined via the first joining portion and the second joining portion in a mode in which the second member and the third member are opposed to each other with the first member sandwiched therebetween in such a manner that the first member and the second member define an internal space and the first member and the third member define an internal space. Therefore, it is possible to reduce the weight while increasing the strength and rigidity.

According to the configuration of the fifth aspect of the present invention, the first member, the second member, and the third member each have a pair of through holes arranged in a longitudinal direction to be opposed to each other, and the second member and the third member each include a pair of connecting wall portions that are opposed to each other in a width direction perpendicular to the longitudinal direction and extend in the longitudinal direction to connect peripheral wall portions of the through holes to each other, and a rib that extends in the longitudinal direction between the connecting wall portions to connect the peripheral wall portions of the through holes to each other. A width of the pair of connecting wall portions in the width direction is set to be the thickest in a center portion in the longitudinal direction, and a height of the rib in a height direction perpendicular to the longitudinal direction and the width direction is set to be the lowest in a center portion thereof in the longitudinal direction. Therefore, it is possible to obtain an efficient shape that can use a resin material without waste to improve a yield, and is also possible to reduce the weight while increasing the strength and rigidity.

### BRIEF DESCRIPTION OF THE DRAWINGS

FIG. 1 is a perspective view of a lower arm shown as an example of a metal-resin composite member according to an embodiment of the present invention;

FIG. 2 is an exploded view of the lower arm in FIG. 1;

FIG. 3 is a plan view of a metal member that is a constituent element of the lower arm shown as an example of the metal-resin composite member according to the present embodiment;

FIG. 4 is a plan view of a resin member that is a constituent element of the lower arm shown as an example of the metal-resin composite member according to the present embodiment, and shows the resin member located on the z-axis positive-direction side with respect the metal member in FIGS. 1 and 2 with a coordinate system matched with a coordinate system in FIGS. 1 and 2 for the sake of convenience;

FIG. 5 is a bottom view of the resin member that is a constituent element of the lower arm shown as an example of the metal-resin composite member according to the present embodiment, and shows the resin member located on the z-axis positive-direction side with respect the metal member in FIGS. 1 and 2 with a coordinate system matched with the coordinate system in FIGS. 1 and 2 for the sake of convenience;

FIG. 6 is a cross-sectional view along a line C-C in FIG. 4;

FIG. 7 is a cross-sectional view along a line A-A in FIG. 1;

FIG. 8 is a cross-sectional view along a line B-B in FIG. 1 and shows a state where a bush is assembled for the sake of convenience;

FIG. 9A is an X-ray CT image of one of the resin members that are constituent elements of the lower arm shown as an example of the metal-resin composite member according to the present embodiment, positionally corresponding to FIG. 7;

FIG. 9B is a cross-sectional view showing the metal member that is a constituent element of the lower arm, positionally corresponding to FIG. 7; and

FIG. 10 is a cross-sectional view of a lower arm shown as another example of the metal-resin composite member according to the present embodiment, positionally corresponding to FIG. 7.

### DETAILED DESCRIPTION OF THE PREFERRED EMBODIMENT

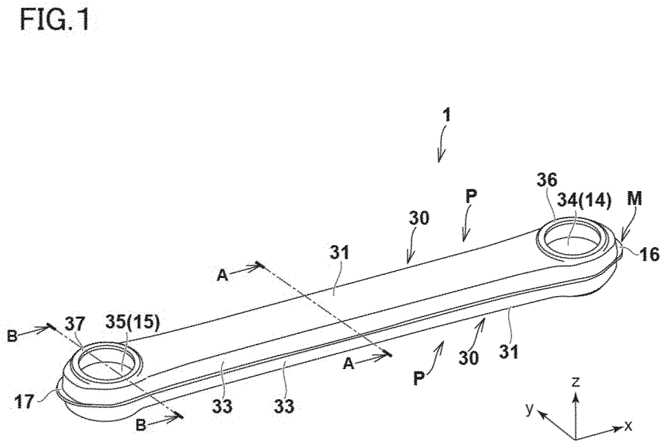

A metal-resin composite member according to an embodiment of the present invention will be explained below in detail with reference to FIG. 1 to FIG. 10 as appropriate. In the drawings, an x-axis, a y-axis, and a z-axis form a triaxial orthogonal coordinate system.

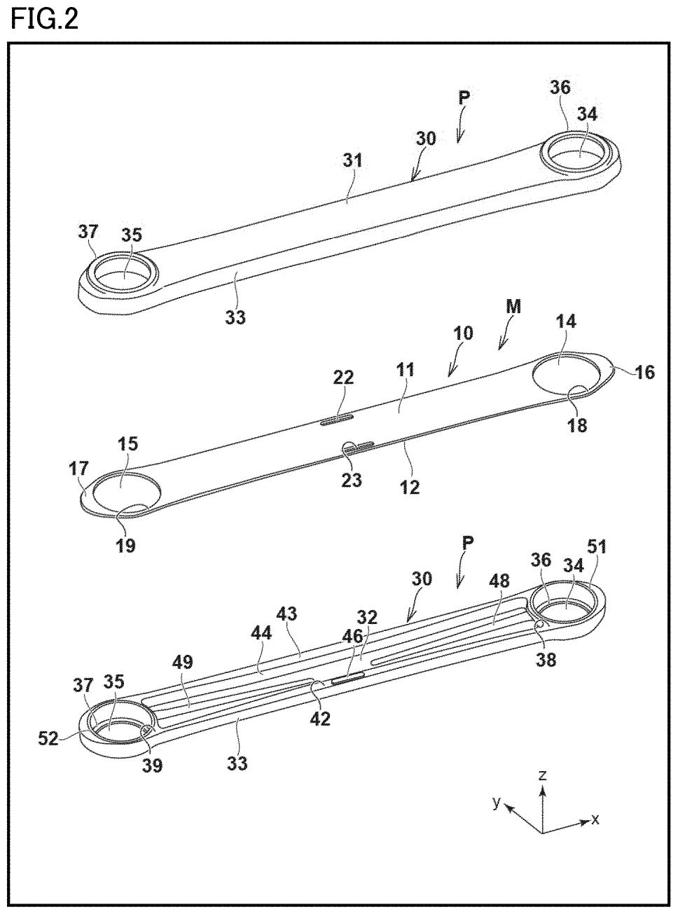

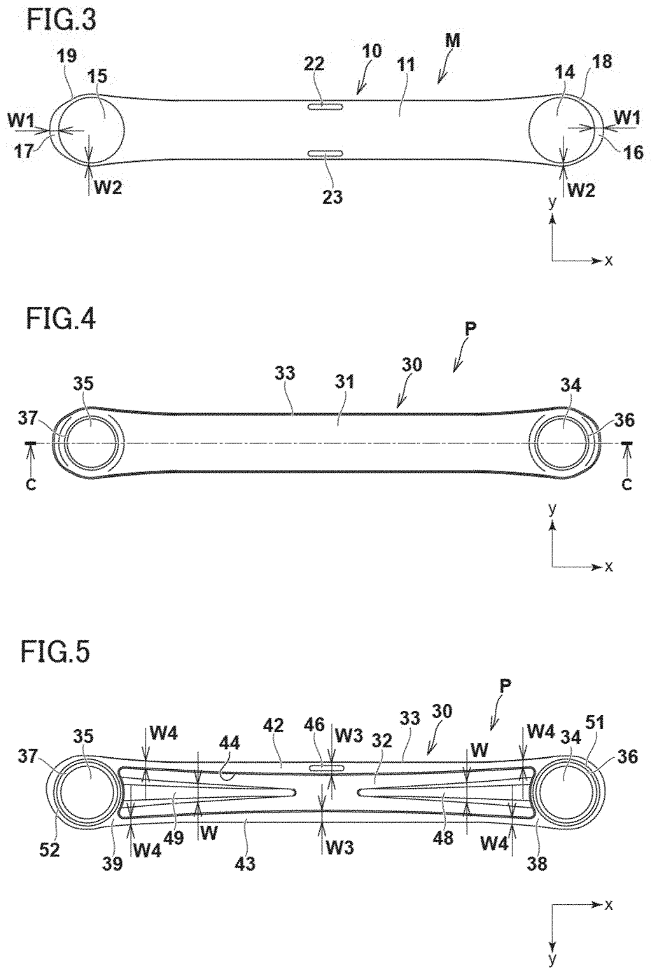

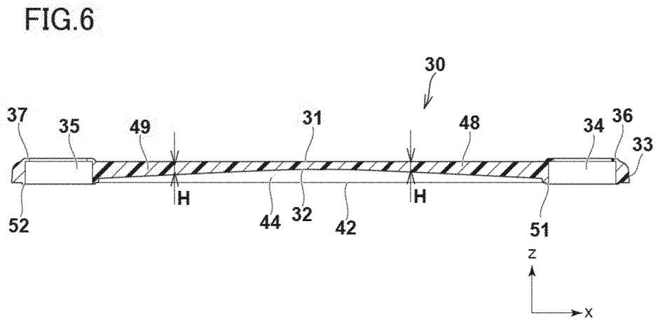

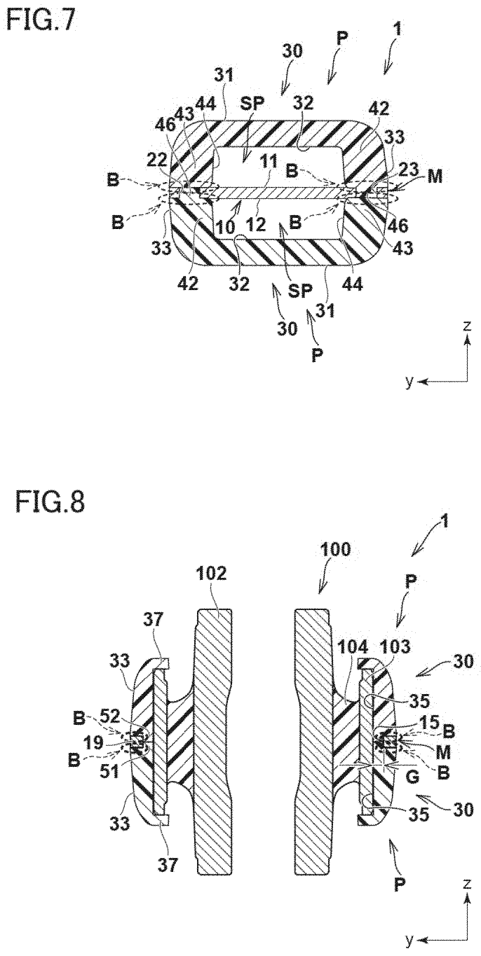

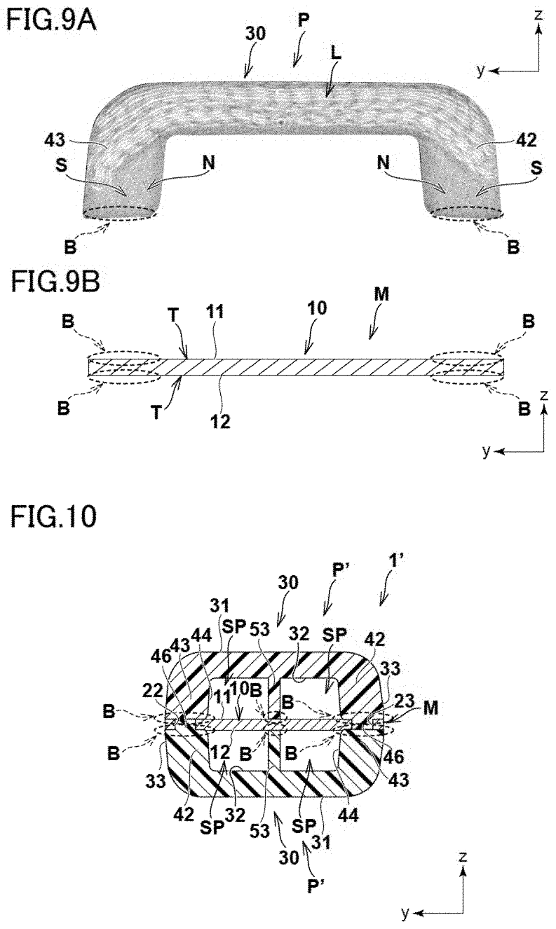

FIG. 1 is a perspective view of a lower arm shown as an example of the metal-resin composite member according to the present embodiment, and FIG. 2 is an exploded view of the lower arm in FIG. 1. FIG. 3 is a plan view of a metal member that is a constituent element of the lower arm shown as an example of the metal-resin composite member according to the present embodiment. FIGS. 4 and 5 are a plan view and a bottom view of a resin member that is a constituent element of the lower arm shown as an example of the metal-resin composite member according to the present embodiment, respectively, and show the resin member located on the z-axis positive-direction side with respect the metal member in FIGS. 1 and 2 with a coordinate system matched with a coordinate system in FIGS. 1 and 2 for the sake of convenience. FIG. 6 is a cross-sectional view along a line C-C in FIG. 4, FIG. 7 is a cross-sectional view along a line A-A in FIG. 1, and FIG. 8 is a cross-sectional view along a line B-B in FIG. 1. FIG. 8 shows a state where a bush is assembled for the sake of convenience. FIG. 9A is an X-ray CT image of one of the resin members that are constituent elements of the lower arm shown as an example of the metal-resin composite member according to the present embodiment and FIG. 9B is a cross-sectional view showing the metal member that is a constituent element of the lower arm, both positionally corresponding to FIG. 7. FIG. 10 is a cross-sectional view of a lower arm shown as another example of the metal-resin composite member according to the present embodiment, positionally corresponding to FIG. 7.

As shown mainly in FIGS. 1 and 2, a lower arm 1 shown as an example of a metal-resin composite member includes a metal member M and a pair of resin members P and is used as a link member of a suspension system of a vehicle such as a four-wheeled automobile. In FIGS. 1 and 2, the metal member M and the pair of resin members P form joining portions in cooperation with each other to be mutually joined correspondingly in a mode in which the resin members P are arranged on the z-axis positive-direction side and the z-axis negative-direction side of the metal member M, respectively, to sandwich the metal member M therebetween, as an example. It is preferable that the pair of resin members P are molded products having the same structure in design. In this case, one of the resin members P, located on the z-axis negative-direction side, has a mode obtained by turning the other resin member P by 180 degrees around the x-axis. Further, a main input load on the lower arm 1 is typically a compressive/tensile load in the x-axis direction.

As shown mainly in FIG. 3, the metal member M is typically made of aluminum. In FIG. 3, the metal member M is a plate-shaped member that is a press-molded product with its longitudinal direction defined in the x-axis direction, as an example.

Specifically, it is preferable that the metal member M mainly includes a main body portion 10 and through holes 14 and 15. The main body portion 10 is in a form of a flat plate that has a longitudinal direction and a lateral direction (a short direction) in the x-axis direction and the y-axis direction, respectively, and is parallel to the x-y plane. The through holes 14 and 15 penetrate through both end portions in the x-axis direction of the main body portion 10 between a front surface 11 and a back surface 12 that are opposed to each other in the z-axis direction in the main body portion 10 correspondingly.

In the main body portion 10, it is preferable that a peripheral portion of the through hole 14 on the x-axis positive-direction side forms a wide portion 16 of which a width W1 in the x-axis direction increases from the through hole 14 to the x-axis positive-direction side, and a peripheral portion of the through hole 15 on the x-axis negative-direction side forms a wide portion 17 of which the width W1 in the x-axis direction increases from the through hole 15 to the x-axis negative-direction side. That is, the width W1 of the wide portions 16 and 17 is set to be larger than a width W2 of peripheral portions 18 and 19 of the corresponding through holes 14 and 15 other than the wide portions 16 and 17 in the main body portion 10. Due to this setting, it is possible to improve the strength and rigidity of hole wall portions of the through holes 14 and 15. Further, it is preferable that through holes 22 and 23 are provided in a center portion in the x-axis direction of the main body portion 10 to be opposed to each other in the y-axis direction, the through holes 22 and 23 penetrating through the center portion between the front surface 11 and the back surface 12 correspondingly and having a shape of an elongated hole. It is preferable that a width of each of portions between the wide portions 16 and 17 and the corresponding peripheral portions 18 and 19 connected thereto is set to change smoothly.

In the main body portion 10, the front surface 11 and the back surface 12 are each subjected to a process of increasing an area of contact with a member to be in contact therewith. This process includes various types of processes including a mechanical process, an electric process, and a chemical process for making the front surface 11 and the back surface 12 rough or porous. In FIG. 9B, portions of the front surface 11 and the back surface 12 that have been subjected to this process are schematically shown as portions T, and portions that correspond to joining portions described later are schematically shown as portions B.

As shown mainly in FIGS. 4 to 6, the resin member P is typically made of fiber-reinforced synthetic resin. Among various types of fiber-reinforced synthetic resin, CFRTP (Carbon Fiber Reinforced Thermo Plastics) can be used preferably, for example. The resin member P is an integrally molded concave member that defines its longitudinal direction in the x-axis direction in FIGS. 4 to 6 as an example, and is a product molded by press molding, for example. If necessary, the resin member P may be a product molded by injection molding or the like, or thermosetting synthetic resin may be used rather than thermoplastic resin.

Specifically, it is preferable that the resin member P mainly includes a main body portion 30, a front wall portion 31 and a back wall portion 32, an outer wall portion 33, and through holes 34 and 35. The main body portion 30 has a longitudinal direction and a lateral direction (a short direction) in the x-axis direction and the y-axis direction, respectively, and is concave in vertical cross sections respectively cut along a plane parallel to the x-z plane and a plane parallel to the y-z plane. The front wall portion 31 and the back wall portion 32 are opposed to each other in the z-axis direction in the main body portion 30. The outer wall portion 33 connects the front wall portion 31 and the back wall portion 32 to each other in the main body portion 30. The through holes 34 and 35 penetrate through both end portions in the x-axis direction of the main body portion 30 between the front wall portion 31 and the back wall portion 32 correspondingly.

It is preferable that retaining flange portions 36 and 37 are provided for the through holes 34 and 35, respectively, each of which extends from a hole wall portion on the front wall portion 31 side of a corresponding one of the through holes 34 and 35 towards a hole axis to overhang. In this case, the diameters of the through holes 34 and 35 are reduced by the retaining flange portions 36 and 37, respectively, on the front wall portion 31 side. On the back wall portion 32 side of the through holes 34 and 35, it is preferable that peripheral wall portions 38 and 39 are respectively provided to stand from the back wall portion 32 and protrude to the z-axis negative direction, and the through holes 34 and 35 also penetrate through the peripheral wall portions 38 and 39 in the z-axis direction. The peripheral wall portions 38 and 39 are preferably connected to each other by connecting wall portions 42 and 43 that stand from the back wall portion 32 at both end portions in the y-axis direction to protrude to the z-axis negative direction and extend in the x-axis direction correspondingly. In this case, the outer wall portion 33 is configured by outer wall portions of the peripheral wall portions 38 and 39 and outer wall portions of the connecting wall portions 42 and 43. An inner wall portion 44 is configured by inner wall portions of the peripheral wall portions 38 and 39 and inner wall portions of the connecting wall portions 42 and 43. The main body portion 30 is concave in vertical cross sections respectively cut along a plane parallel to the x-z plane and a plane parallel to the y-z plane. A width W3 in the y-axis direction of center portions in the x-axis direction of the connecting wall portions 42 and 43 is preferably set to be larger than a width W4 in the y-axis direction of corresponding both end portions of the connecting wall portions 42 and 43, the end portions being on a side apart from the center portions in the x-axis direction of the connecting wall portions 42 and 43. It is preferable that widths of portions between the center portions in the x-axis direction of the connecting wall portions 42 and 43 and the corresponding both end portions on the side apart from these center portions in the x-axis direction are set to smoothly change.

It is preferable that a convex portion 46 is provided in one of the connecting wall portions 42 and 43, that is, in the connecting wall portion 42 as an example. The convex portion 46 is provided in a center portion in the x-axis direction of a tip portion of the connecting wall portion 42 on a side on which that connecting wall portion 42 stands from the back wall portion 32 and protrudes to the z-axis negative direction, protrudes further from that center portion, and is elliptical in a lateral cross section cut along a plane parallel to the x-y plane. In this case, the convex portion 46 is capable of being inserted to a corresponding one of the through holes 22 and 23 of the metal member M.

The back wall portion 32 is preferably provided with reinforcing ribs 48 and 49 that extend in the x-axis direction between a center portion in the x-axis direction of the back wall portion 32 and the corresponding peripheral wall portions 38 and 39. It is preferable that a width W in the y-axis direction of the reinforcing ribs 48 and 49 becomes smaller smoothly and gradually from the corresponding peripheral wall portions 38 and 39 toward the center portion in the x-axis direction of the back wall portion 32. It is also preferable that a height H in the z-axis direction of the reinforcing ribs 48 and 49 from the back wall portion 32 becomes lower smoothly and gradually from the corresponding peripheral wall portions 38 and 39 toward the center portion in the x-axis direction of the back wall portion 32. Due to the configuration of the reinforcing ribs 48 and 49 having this shape and the configuration of the connecting wall portions 42 and 43 having the shapes related to the widths in the y-axis direction described above, it is possible to appropriately balance the strength and the rigidity of the main body portion 30.

In the peripheral wall portions 38 and 39, it is preferable that partition walls 51 and 52 are provided at tip portions thereof on the side on which the peripheral wall portions 38 and 39 stand from the back wall portion 32 and protrude to the z-axis negative direction in such a manner that the partition walls 51 and 52 that surround the corresponding through holes 34 and 35 stand and protrude to the z-axis negative direction.

A resin material that forms the resin member P may be configured by short fibers (discontinuous fibers) and continuous fibers that are relatively longer in the fiber length than the short fibers (the discontinuous fibers) solely or in combination. Further, these fibers may be distributed evenly or unevenly. Furthermore, a plurality of resin sheets including these fibers may be used and stacked in such a manner that the same type of resin sheets is successively stacked or different types of resin sheets are alternately stacked. Typically, from the viewpoint of including a portion L where the continuous fibers are arranged, a portion S where the discontinuous fibers are arranged, and a portion N where the continuous fibers and the discontinuous fibers are not arranged and the viewpoint of preferably setting a joining portion B described later to reduce a difference of a liner expansion coefficient between the resin member P and the metal member M and to increase the joining strength, it is preferable to set the joining portion B not to include the portion L where the continuous fibers are arranged, as shown in FIG. 9A. In other words, it is preferable to set the joining portion B to include both or one of the portion S where the short fibers (the discontinuous fibers) are arranged and the portion N of the resin material that includes neither the portion L where the continuous fibers are arranged nor the portion S where the short fibers (the discontinuous fibers) are arranged. Further, in this configuration, the portion L where the continuous fibers are arranged is arranged in the main body portion 30 that is required to have high strength.

Further, as shown mainly in FIGS. 7 and 8, it is preferable that the joining portions B that are defined by the metal member M and each of the pair of resin members P in cooperation with each other are formed in portions where peripheral portions of the front surface 11 and the back surface 12 of the main body portion 10 of the metal member M along an outer contour thereof and peripheral portions respectively surrounding the through holes 14 and 15, and tip portions (that are typically flat portions parallel to the x-y plane) of the peripheral wall portions 38 and 39 and the connecting wall portions 42 and 43 of the main body 30 of each of the resin members P, which respectively correspond to these peripheral portions, on a side on which the walls 38, 39, 42, and 43 stand from the back wall portion 32 and protrude to the z-axis negative direction are mutually joined. At this time, the joining portion B formed by cooperation with the processed portion T of the front surface 11 and the joining portion B formed by cooperation with the processed portion T of the back surface 12 have a plane-symmetric positional relation with respect to a flat-plate portion of the main body portion 10 in such a manner that both the joining portions B overlap on each other via the main body portion 10 as viewed in the z-axis direction. Further, when such joining is performed, an end portion of the metal member M which corresponds to the outer contour thereof may be embedded inside the pair of resin members P not to be exposed. In addition, due to such joining, the lower arm 1 typically has a closed cross-section structure that has a space SP therein. Furthermore, in a lower arm 1′ of another example shown in FIG. 10, the main body portion 30 of each of a pair of resin members P′ includes a convex portion 53 that extends towards the metal member M in a portion that is a center portion in the y-axis direction between the connecting wall portions 42 and 43 and is a center portion in the z-axis direction where the reinforcing ribs 48 and 49 are not provided. Tip portions of the convex portions 53 form the joining portions B together with the processed portions T of the front surface 11 and the back surface 12 of the main body portion 10 of the metal member M and are joined. Therefore, these convex portions 53 enter the internal space SP of the lower arm 1′. The convex portion 53 may be displaced from the center portion in the y-axis direction between the connecting wall portions 42 and 43, and the number of the convex portions 53 is not limited to one but may be plural.

Further, the bush 100 is a suspension bush, and includes an inner collar member 102 that extends in the z-axis direction and is typically made of metal, an outer collar member 103 that surrounds the inner collar member 102 coaxially therewith and is typically made of metal, and an anti-vibration rubber material 104 interposed between the inner collar member 102 and the outer collar member 103 in FIG. 8 as an example. When this bush 100 is attached to the lower arm 1, the outer collar member 103 is inserted into the corresponding through hole 14 or 15 of the main body portion 10 of the metal member M and the corresponding through holes 34 or 35 of the main body portions 30 of the pair of resin members P, and both end portions in the z-axis direction of the outer collar member 103 abut on the corresponding retaining flange portions 36 or 37 of the main body portions 30 of the pair of resin members P and are held. In this manner, the bush 100 is retained with respect to the lower arm 1.

A manufacturing method of the lower arm 1 having the configuration described above is described below.

First, the metal member M, two resin members P, and two bushes 100 are prepared in advance.

Next, by setting the metal member M, the two resin members P, and the two bushes 100 to have a mode shown in FIG. 8, respectively, the two bushes 100 are inserted into the corresponding through holes 14 and 15 of the main body portion 10 of the metal member M and the corresponding through holes 34 and 35 of the main body portions 30 of the two resin members P, while the back wall portion 32 of one of the two resin members P is opposed to the front surface 11 of the metal member M and the back wall portion 32 of the other of the two resin members P is opposed to the back surface 12 of the metal member M. At this time, the through holes 14 and 34 are correspondingly arranged coaxially with each other about an axis parallel to the z-axis, and the through holes 15 and 35 are correspondingly arranged coaxially with each other about an axis parallel to the z-axis. In addition, peripheral portions of the front surface 11 and the back surface 12 of the main body portion 10 of the metal member M along an outer contour thereof and peripheral portions respectively surrounding the through holes 14 and 15, and tip portions of the peripheral wall portions 38 and 39 and the connecting wall portions 42 and 43 of the main body portion 30 of each of the two resin members P corresponding to these peripheral portions on a side on which the peripheral wall portions 38 and 39 and the connecting wall portions 42 and 43 stand from the back wall portion 32 and protrude to the z-axis negative direction, the tip portions being flat portions parallel to the x-y plane, are pressed against each other in a direction parallel to the z-axis while being mutually opposed to overlap on each other via the main body portion 10 of the metal member M as viewed in the z-axis direction. Further, at this time, heat may be applied to abutting interfaces between the peripheral portions and the tip portions that are mutually pressed to raise the temperature. An additional coupling structure, for example, an adhesive or a rivet may be used together, as necessary.

The tip portions of the peripheral wall portions 38 and 39 and the connecting wall portions 42 and 43 of the main body portion 30 of one of the two resin members P on the side on which these walls 38, 39, 42, and 43 stand from the back wall portion 32 and protrude, and the peripheral portion of the front surface 11 of the metal member M are joined to each other to define the joining portion B. Also, the tip portions of the peripheral wall portions 38 and 39 and the connecting wall portions 42 and 43 of the main body portion 30 of the other of the two resin members P on the side on which these walls 38, 39, 42, and 43 stand from the back wall portion 32 and protrude, and the peripheral portion of the back surface 12 of the metal member M are joined to each other to define the joining portion B. In addition, both end portions in the z-axis direction of the outer collar member 103 of each of the two bushes 100 are held while being positioned by abutting on the corresponding retaining flange portions 36 and 37 of the main body portion 30 of each of the two resin members P. In this manner, the lower arm 1 is configured. At this time, as shown mainly in FIG. 7, the convex portions 46 of the two resin members P are respectively inserted into the corresponding through holes 22 and 23 of the metal member M to position the metal member M and the two resin members P. Simultaneously, as shown mainly in FIG. 8, the partition walls 51 and 52 of the two resin members P are inserted into the corresponding through holes 14 and 15 of the metal member M, respectively, to separate the main body portion 10 of the metal member M from the outer collar members 103 of each of the two bushes 100 with a gap G via the resin member P and to be electrically insulated from each other.

In the present embodiment described above, in the metal-resin composite member 1 or 1′, the first member M made of metal and the second member P or P′ made of resin are joined to each other via the first joining portion B that is defined by the first member M and the second member P or P′ in cooperation with each other, and the first member M made of metal and the third member P or P′ made of resin are joined to each other via the second joining portion B that is defined by the first member M and the third member P or P′ in cooperation with each other. Therefore, it is possible to reduce the weight while the strength and rigidity are secured at a same or higher level thereof without using any complicated mold.

Further, in the present embodiment, the resin configuring the second member P or P′ and the resin configuring the third member P or P′ include the portion L where continuous fibers are arranged, the portion S where discontinuous fibers are arranged, and the portion N where the continuous fibers and the discontinuous fibers are not arranged, and the first joining portion B and the second joining portion B are configured by at least one of the portion S where the discontinuous fibers are arranged and the portion N where the continuous fibers and the discontinuous fibers are not arranged. Therefore, by using a relation that a linear expansion coefficient of each of the portion S where the discontinuous fibers are arranged and the portion N where the continuous fibers and the discontinuous fibers are not arranged is closer to a linear expansion coefficient of a metal portion than a linear expansion coefficient of the portion L where the continuous fibers are arranged, it is possible to fill a gap between the linear expansion coefficient of the portion L where the continuous fibers are arranged and the linear expansion coefficient of the metal portion with the linear expansion coefficient of each of the portion S where the discontinuous fibers are arranged and the portion N where the continuous fibers and the discontinuous fibers are not arranged correspondingly, to realize a smooth change between the linear expansion coefficient of the portion L where the continuous fibers are arranged and the linear expansion coefficient of the metal portion, so that the use durability of the metal-resin composite member 1 or 1′ with respect to a temperature change can be increased. In addition, it is possible to increase the strength of joining between the resin member P or P′ and the metal member M by using a relation that the portion S where the discontinuous fibers are arranged and the portion N where the continuous fibers and the discontinuous fibers are not arranged are higher in the strength of joining to the metal portion than the portion L where the continuous fibers are arranged.

Furthermore, in the present embodiment, the first member M, the second member P or P′, and the third member P or P′ have the through holes 14, 15, 34, and 35, and are mutually joined via the first joining portion B and the second joining portion B in a mode in which the second member P or P′ and the third member P or P′ are opposed to each other with the first member M sandwiched therebetween in such a manner that the through holes 14 and 34 are arranged coaxially with each other, the through holes 15 and 35 are arranged coaxially with each other, and these through holes 14, 15, 34, and 35 allow insertion of the bushes 100 thereinto. Further, the second member P or P′ and the third member P or P′ each have the flange portions 36 and 37 that respectively correspond to the through hole 34 and 35, and the bushes 100 are retained by the flange portions 36 and 37 of the second member P or P′ and the flange portions 36 and 37 of the third member P or P′. Therefore, it is possible to suppress separation of the lower arm 1 or 1′ in the metal member M when the second member P or P′ and the third member P or P′ are broken, and is also possible to position and retain the bushes 100 by the flange portions 36 and 37.

In addition, in the present embodiment, the first member M, the second member P or P′, and the third member P or P′ are mutually joined via the first joining portion B and the second joining portion B in a mode in which the second member P or P′ and the third member P or P′ are opposed to each other with the first member M sandwiched therebetween in such a manner that the first member M and the second member P or P′ define the internal space SP and the first member M and the third member P or P′ define the internal space SP. Therefore, it is possible to reduce the weight while increasing the strength and rigidity.

Furthermore, in the present embodiment, the second member P or P′ and the third member P or P′ each have the pair of through holes 14 and 15, 34 and 35 arranged in the longitudinal direction to be opposed to each other, and the second member P or P′ and the third member P or P′ each include the pair of connecting wall portions 42 and 43 that are opposed to each other in the width direction perpendicular to the longitudinal direction and extend in the longitudinal direction to connect the peripheral wall portions 38 and 39 of the pair of through holes 34 and 35 to each other, and the ribs 48 and 49 that extend in the longitudinal direction between the pair of connecting wall portions 42 and 43 to connect the peripheral wall portions 38 and 39 of the through holes 34 and 35 to each other. A width of the pair of connecting wall portions 42 and 43 in the width direction is set to be the thickest in a center portion in the longitudinal direction, and a height of the ribs 48 and 49 in the height direction perpendicular to the longitudinal direction and the width direction is set to be the lowest in a center portion in the longitudinal direction. Therefore, it is possible to obtain an efficient shape that can use a resin material without waste to improve a yield, and is also possible to reduce the weight while increasing the strength and rigidity.

In the present invention, the form, arrangement, number, and the like of the constituent elements are not limited to those in the embodiment explained above, and it is needless to mention that the constituent elements can be modified as appropriate without departing from the scope of the invention, such as appropriately replacing these elements by other ones having identical operational effects.

As described above, according to the present invention, it is possible to provide a metal-resin composite member capable of reducing the weight while the strength and rigidity are secured at a same or higher level thereof without using any complicated mold. Therefore, because of its general purposes and universal characteristics, applications of the present invention can be expected in a wide range in a field of strength parts of a vehicle and the like.

What is claimed is:

1. A metal-resin composite member comprising:
a first member made of metal;
a second member made of resin; and
a third member made of resin,
wherein the first member and the second member are joined to each other via a first joining portion defined by the first member and the second member in cooperation with each other, and the first member and the third member are joined to each other via a second joining portion defined by the first member and the third member in cooperation with each other.

2. The metal-resin composite member according to claim 1,
wherein the resin configuring the second member and the resin configuring the third member include a portion where continuous fibers are arranged, a portion where discontinuous fibers are arranged, and a portion where the continuous fibers and the discontinuous fibers are not arranged,
and wherein the first joining portion and the second joining portion are configured by at least one of the portion where the discontinuous fibers are arranged and the portion where the continuous fibers and the discontinuous fibers are not arranged.

3. The metal-resin composite member according to claim 1,
wherein the first member, the second member, and the third member have through holes, respectively, and are mutually joined via the first joining portion and the second joining portion in a mode in which the second member and the third member are opposed to each other with the first member sandwiched therebetween in such a manner that the through holes are arranged coazially with one another to correspondingly allow insertion of bushes therethrough,
wherein the second member and the third member include flange portions respectively corresponding to the through holes,
and wherein the bushes are retained by the flange portions of the second member and the third member.

4. The metal-resin composite member according to claim 1, wherein the first member, the second member, and the third member are mutually joined via the first joining portion and the second joining portion in a mode in which the second member and the third member are opposed to each other with the first member sandwiched therebetween in such a manner that the first member and the second member define an internal space and the first member and the third member define an internal space.

5. The metal-resin composite member according to claim 1,
wherein the first member, the second member, and the third member each have a pair of through holes arranged in longitudinal direction to be opposed to each other,
wherein the second member and the third member each include a pair of connecting wall portions that are opposed to each other in a width direction perpendicular to the longitudinal direction and extend in the longitudinal direction to connect peripheral wall portions of the pair of through holes to each other, and a rib that extends in the longitudinal direction at a portion between the pair of connecting wall portions to connect the peripheral wall portions of the pair of through holes to each other,
and wherein a width of each of the pair of connecting wall portions in the width direction is set to be the thickest in a center portion in the longitudinal direction, and a height of the rib in a height direction perpendicular to the longitudinal direction and the width direction is set to be the lowest in a center portion in the longitudinal direction.
